(19) United States
(12) Patent Application Publication
(10) Pub. No.: US 2026/0237010 A1
(43) Pub. Date: Aug. 13, 2026

(54) COPYRIGHT RISK DETERMINATION APPARATUS, COPYRIGHT RISK DETERMINATION SYSTEM, COPYRIGHT RISK DETERMINATION METHOD, AND STORAGE MEDIUM

(71) Applicant: Konica Minolta, Inc., Tokyo (JP)

(72) Inventor: Taro TAKECHI, Tokyo (JP)

(21) Appl. No.: 19/532,758

(22) Filed: Feb. 6, 2026

(30) Foreign Application Priority Data
Feb. 12, 2025 (JP) 2025-020474

(51) Int. Cl. G06Q 50/18; G06Q 10/0635

(52) U.S. Cl. CPC G06Q 50/184; G06Q 10/0635

(57) ABSTRACT

A copyright risk determination apparatus including a hardware processor that determines a risk that character information for causing an AI to generate a product is related to an existing copyrighted material.

### CROSS-REFERENCE TO RELATED APPLICATIONS

The entire disclosure of Japanese Patent Application No. 2025-020474 filed on February 12, 2025 is incorporated herein by reference in its entirety.

### BACKGROUND OF THE INVENTION

### Technical Field

The present disclosure relates to a copyright risk determination apparatus, a copyright risk determination system, a copyright risk determination method, and a storage medium.

### Description of Related Art

Recently, artificial intelligence (AI) has been known which generates a product such as an image or a sentence by inputting text (character information). When a product is generated using such an AI, a product similar to an existing product may be generated, and there is a risk of copyright infringement.

Japanese Unexamined Patent Publication No. 2024-43428 (A) describes that the risk of copyright infringement is reduced by acquiring existing information related to an existing object belonging to the same category as the product and determining the similarity between the product and the existing object.

### SUMMARY OF THE INVENTION

However, even if the invention described in Japanese Unexamined Patent Publication No. 2024-43428 can reduce the risk of piracy of the produced product, it cannot suppress the production of a product having a high risk of piracy.

Therefore, an object of the present disclosure is to further reduce generation of a product having a high copyright infringement risk when the product is generated using AI.

To achieve at least one of the abovementioned objects, according to an aspect of the present invention, copyright risk determination apparatus reflecting one aspect of the present invention comprises a hardware processor that determines a risk that character information for causing an AI to generate a product is related to an existing copyrighted material.

### BRIEF DESCRIPTION OF THE DRAWINGS

The advantages and features provided by one or more embodiments of the invention will become more fully understood from the detailed description given hereinbelow and the appended drawings which are given by way of illustration only, and thus are not intended as a definition of the limits of the present invention, wherein:

FIG. 1 is a block diagram illustrating a configuration of a copyright risk determination system;

FIG. 2 is a flowchart of copyright risk determining processing;

FIG. 3 is an image diagram of an input screen;

FIG. 4 is an image diagram of a warning display;

FIG. 5 is an image diagram of an image generation support screen; and

FIG. 6 is an image diagram of a warning display.

### DETAILED DESCRIPTION

Hereinafter, one or more embodiments of the present invention will be described with reference to the drawings. However, the scope of the invention is not limited to the disclosed embodiments.

Hereinafter, embodiments of the present disclosure will be described with reference to the drawings. However, the scope of the present disclosure is not limited to the following embodiment and drawings.

### Copyright Risk Determination System 100

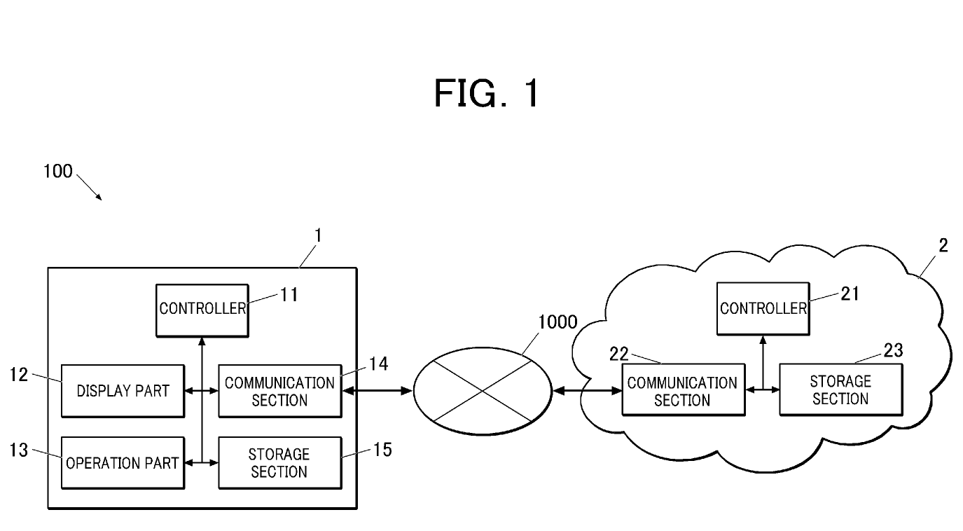

First, a configuration of a copyright risk determination system 100 will be described with reference to FIG. 1. As illustrated in FIG. 1, the copyright risk determination system 100 includes an image generation supporting apparatus 1 and a cloud server 2. The image generation supporting apparatus 1 and the cloud server 2 (copyright risk determination apparatus) transmit and receive information to and from each other via the communication network 1000.

The image generation supporting apparatus 1 is an apparatus to which a user inputs text data (character information), and is an apparatus that displays a product generated by the cloud server 2 based on the input text data.

The product is, for example, an image or a sentence.

Note that the following description will be given basically using a case where the product is an image.

The cloud server 2 is an AI device that generates a prompt from text data input using AI and generates a product from the prompt using AI.

The cloud server 2 is a device that determines a risk (copyright risk) that a product infringes the copyright of an existing product.

Note that the cloud server 2 may be an on-premise apparatus.

The communication network 1000 is a local area network (LAN), a wide area network (WAN), the Internet, or the like.

### image generation supporting apparatus 1

Next, a configuration of the image generation supporting apparatus 1 will be described with reference to FIG. 1. As illustrated in FIG. 1, the image generation supporting apparatus 1 includes a controller 11 (hardware processor), a display part 12, an operation part 13, a communication section 14, and a storage section 15.

The controller 11 includes a central processing unit (CPU), a random access memory (RAM), and the like. The CPU of the controller 11 reads various programs stored in the storage section 15, develops the programs in the RAM, executes various processes in accordance with the developed programs, and controls the operation of each unit of the image generation supporting apparatus 1.

The display part 12 includes a monitor such as a liquid crystal display (LCD) and displays various screens (an input screen, a result display screen, and the like which will be described later) according to an instruction of a display signal input from the controller 11.

The operation part 13 includes a keyboard having cursor keys, number input keys, various function keys, and the like, a pointing device such as a mouse, a touch screen layered on the surface of the display part 12, and the like. The operation part 13 is operable by an operator. The operation part 13 outputs various signals to the controller 11 based on operations performed by the operator.

The communication section 14 can transmit and receive various signals and various data to and from other devices and the like connected via the communication network 1000.

The storage section 15 includes a nonvolatile semiconductor memory, a hard disk, and the like, and stores various programs to be executed by the controller 11, parameters required for execution of the programs, various data, and the like.

### cloud server 2

Next, a configuration of the cloud server 2 will be described with reference to FIG. 1. As illustrated in FIG. 1, the cloud server 2 includes a controller 21 (hardware processor), a communication section 22, and a storage section 23.

The controller 21 includes a CPU and RAM. The CPU of the controller 21 reads various programs stored in the storage section 23, develops the programs in the RAM, executes various processes in accordance with the developed programs, and controls the operation of each component of the cloud server 2.

The controller 21 functions as a first risk determination section that determines a risk (copyright risk) that the character information for causing the AI to generate a product is related to an existing copyrighted material.

The controller 21 functions as a second risk determination section that calculates the similarity between the product generated by the AI and the existing copyrighted material based on the character information, and determines the risk of similarity (copyright risk).

The controller 21 functions as an extraction section that extracts a feature of the product as feature information.

The controller 21 functions as a third risk determination section that determines, based on the feature information, the presence or absence of an existing copyrighted material similar to the feature, and determines a similar risk (copyright risk).

Note that the character information for causing the user to generate the product is not limited to the character information input by the user, but may include a prompt generated by the AI. Similarly, at the time of re-generating the image, not only the character information input by the user but also a prompt may be included.

To be specific, as the extraction section, the controller 21 extracts a feature of a product by using a large-scale language model (large language model, LLM) learned in advance based on an existing copyrighted material.

For example, ChatGPT (R) is used as a large-scale language model, and APIs of ChatGPT are used.

Specifically, using a large language model (LLM) that has been learned in advance on the basis of existing copyrighted materials, the controller 21, as the first risk determination section, the second risk determination section, and the third risk determination section, determines the risk by comparing information input to the large language model with the existing copyrighted materials.

The controller 21 determines "degree of association 80%" as the first risk determination section, "degree of similarity 50%" as the second risk determination section and the third risk determination section, and with a certain value of the degree of association or the degree of similarity as a reference value, determines "no risk" when the value is equal to or less than the reference value and determines "risk" when the value exceeds the reference value.

The large-scale language model has already been learned based on an existing copyrighted material. Therefore, in the risk determination, it is not necessary to newly acquire existing information. For example, ChatGPT is used as a large-scale language model, and ChatGPT APIs are used.

It should be noted that not only products by AI but also all products are accompanied by copyrights, so that all copyrighted materials cannot be covered, but here, it is assumed that they can be covered by learning a very large amount of data.

The controller 21 functions as a result notification section which allows a display device to display a determination result by at least one of the first risk determination section, the second risk determination section and the third risk determination section.

When at least one of the first risk determination section, the second risk determination section, and the third risk determination section determines that there is a risk, the controller 21 functions as a warning section that causes the display device to display warning information.

The communication section 22 can transmit and receive various signals and various data to and from other devices and the like connected via the communication network 1000.

The storage section 23 includes a nonvolatile semiconductor memory, a hard disk, and the like, and stores various programs to be executed by the controller 21, parameters required for execution of the programs, various data, and the like.

### Copyright risk determining processing

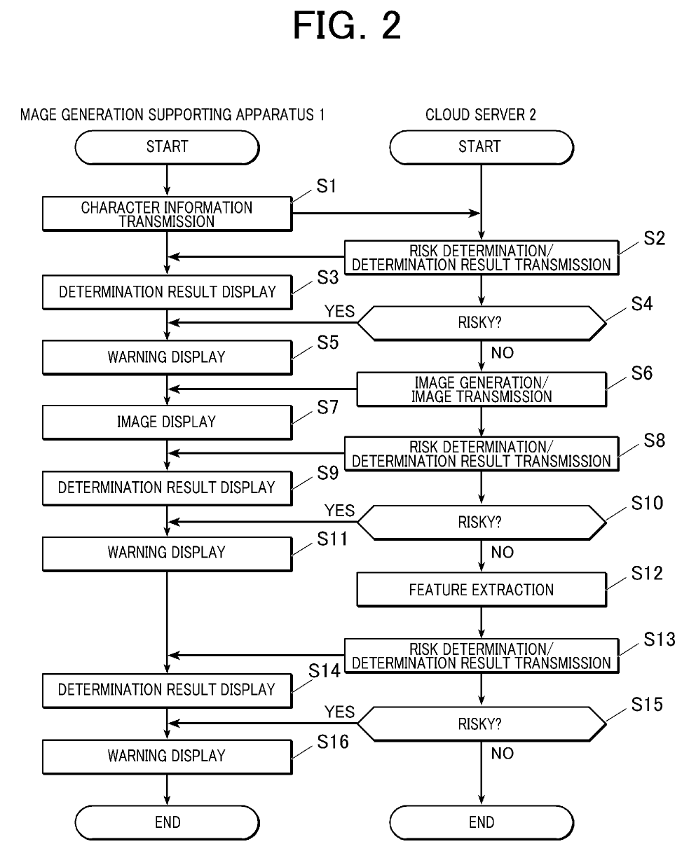

Next, copyright risk determining processing will be described with reference to the flow illustrated in FIG. 2.

The copyright risk determining processing is processing for determining the copyright risk of a product created by AI.

First, a user operates an input screen displayed on the display part 12 by using the operation part 13 to input text data. The controller 11 receives input text data. Next, the user presses an image generation button (button B2), which will be described later, using the operation part 13. The controller 11 sends the text to the cloud server 2 via the communication section 14 (step S1). Note that an image serving as a standard for image generation may be input together with the text data.

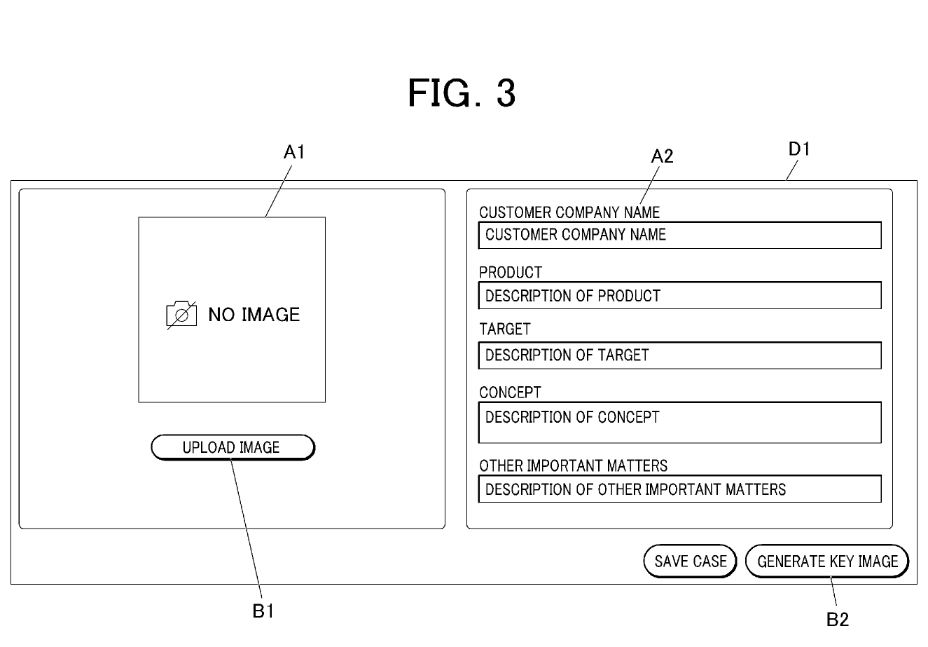

Here, the input screen will be described with reference to FIG. 3.

FIG. 3 is an image diagram of an input screen D1 initially displayed on the display part 12.

The area A1 is an area for displaying an image input by the user.

The area A2 is an area in which the user inputs text.

The button B1 is a button for a user to input an image.

The button B2 is a button for causing the cloud server 2 to generate an image (generate a key image). The key image is a generated image serving as a key for subsequent image generation. In the subsequent image generation, an image is derived from the key image.

Next, the controller 21 of the cloud server 2 determines the risk that the input text is related to an existing copyrighted material and sends the determination result to the image generation supporting apparatus 1 via the communication section 22 (step S2; first risk determining step, result notifying step).

Next, the controller 11 allows the display part 12 to display the determination result (step S3).

Next, in the determination in step S2, when it is determined that there is a risk of copyrights (step S4; YES), the controller 21 transmits warning information to the image generation supporting apparatus 1 via the communication section 22, and advances the copyright-risk determining processing to step S5 (warning step). When it is determined that there is no copyright-risk (step S4; NO), the controller 21 advances the copyright-risk determining processing to step S6.

Next, the controller 11 allows the display part 12 to display warning information (step S5).

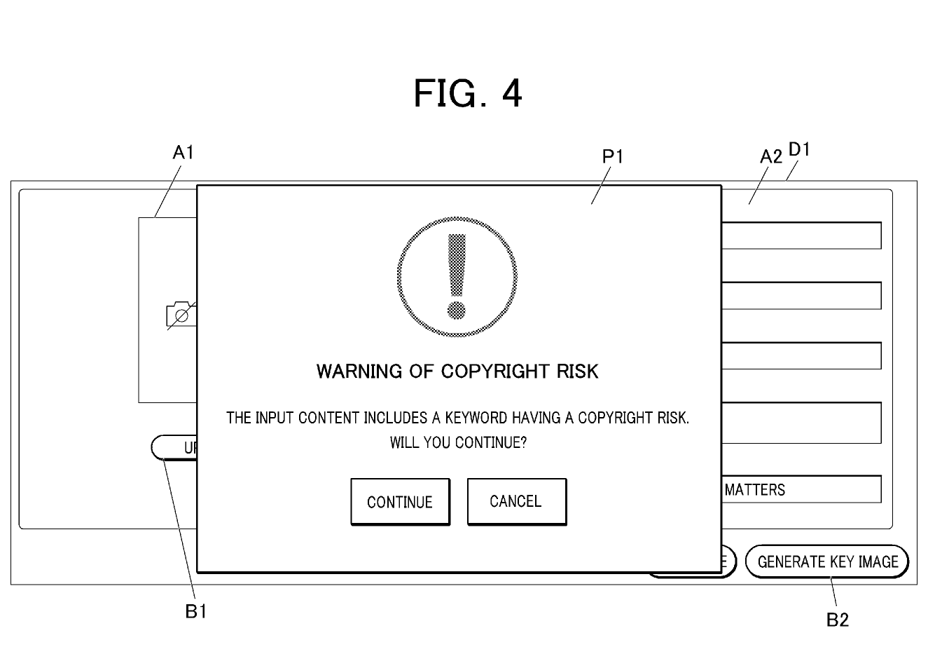

Specifically, the controller 11 displays a warning as shown in FIG. 4. FIG. 4 is an image diagram in which a pop-up D1 for displaying warning information is displayed in front of the input screen P1. When the continue button on the pop-up P1 is pressed, the controller 21 advances the copyright-risk determining processing to the image generation process (step S6). When the cancel button on the pop-up P1 is pressed, the controller 21 advances the copyright-risk determining processing to step S1.

Next, the controller 21 generates an image by AI based on the input text, and transmits the generated image data to the image generation supporting apparatus 1 via the communication section 22 (step S6).

Next, the controller 11 allows the display part 12 to display the generated image generated in step S6 (step S7).

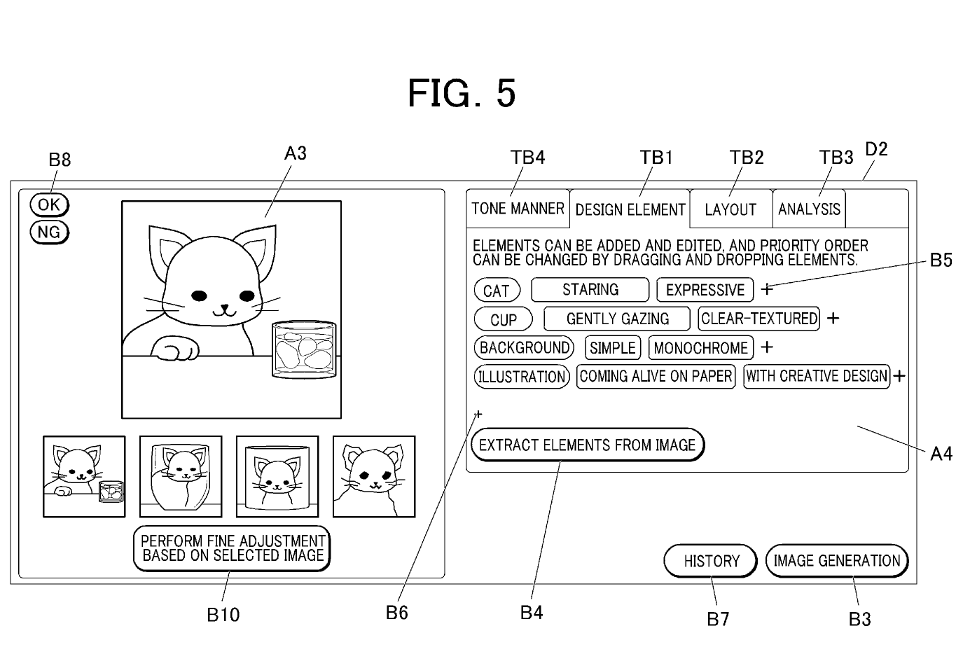

Here, the image generation support screen D2 shown in FIG. 5 will be described.

An area A3 is for displaying a generated image. When plurality of generated images is generated, a selected generated image is displayed in a large size in an upper portion, and the other generated images are displayed in a small size side by side in a lower portion. The initial selection of the selected generated image is the generated image on the left side of the lower portion.

An area A4 is for editing the generated image. The display contents of the area A4 change when the user selects any one of tabs TB1 to TB4.

In FIG. 5, the design-element tab TB1 is selected, and in the area A4, design elements are displayed vertically for each element, and modifiers for each element are displayed horizontally next to each element on the right. Note that the design element is an element that expresses the generated image by combining a noun and a modifier for the noun, and is extracted from the generated image generated by the controller 21 using the image generation AI.

A button B3 is for causing the cloud server 2 to generate an image again.

Next, the controller 21 determines, in step S6, the risk that the generated image is similar to an existing copyrighted material and transmits the determination result to the image generation supporting apparatus 1 via the communication section 22 (step S8; second risk determining step, result notifying step).

Next, the controller 11 allows the display part 12 to display the determination result (step S9).

Next, in the determination in step S8, when it is determined that there is a risk of copyrights (step S10; YES), the controller 21 transmits warning information to the image generation supporting apparatus 1 via the communication section 22, and advances the copyright-risk determining processing to step S11 (warning step). When it is determined that there is no copyright-risk (step S10; NO), the controller 21 advances the copyright-risk determining processing to step S12.

Next, the controller 11 allows the display part 12 to display warning information (step S11).

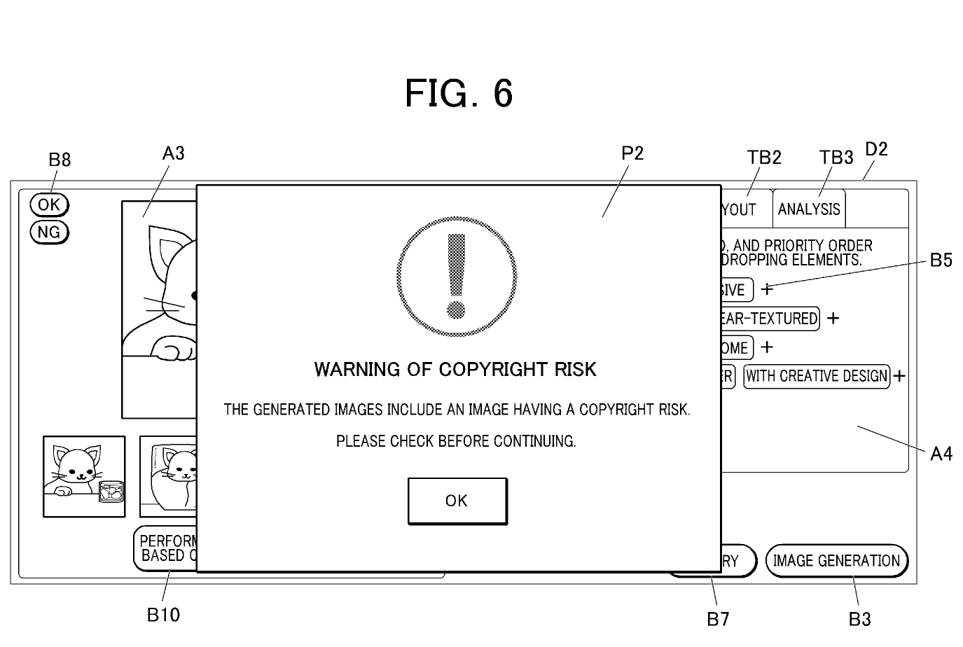

Specifically, the controller 11 displays a warning as shown in FIG. 6. FIG. 6 is an image diagram in which a pop-up P2 for displaying warning information is displayed in front of the image generation support screen D2. When an OK button on the pop-up P2 is pressed, the controller 21 closes the pop-up P2.

Next, the controller 21 extracts a feature of the image generated in step S6 (step S12; extraction step).

Next, the controller 21 determines the risk that the feature extracted in step S11 is similar to an existing copyrighted material, and transmits the determination result to the image generation supporting apparatus 1 via the communication section 22 (step S13; third risk determining step, result notifying step).

Next, the controller 11 allows the display part 12 to display the determination result (step S14).

Next, in the determination in step S13, when it is determined that there is a risk of copyrights (step S15; YES), the controller 21 transmits warning information to the image generation supporting apparatus 1 via the communication section 22, and advances the copyright-risk determining processing to step S16 (warning step). If no risk of copyrights is determined to exist (step S15; NO), the controller 21 ends the copyright-risk determining processing.

Next, the controller 11 causes the display part 12 to display a warning (step S16), and ends the copyright- risk determining processing.

Specifically, the controller 11 displays a warning as shown in FIG. 6. In step S16, the words on the pop-up P2 are replaced with a message "Some of the generated images have similar features and there is a risk of image copyrights. Please check before proceeding. " May be displayed.

### Others

Note that although the product has been described as an image above, it is not limited to this example.

For example, the product may be a text. Specifically, a novel will be described as an example of text information. In the case of sentence information, it is not determined to be similar if the wording does not match, but by doing as described above, it is possible to determine to be similar even in the case where the features of novels such as the transition of stories are similar.

### Effect

As described above, the copyright risk determination apparatus (the cloud server 2)) includes the first risk determination section (the controller 21) that determines the risk that the character information for causing the AI to generate a product is related to an existing copyrighted material.

Therefore, when a product is generated using the AI, generation of a product having a high copyright infringement risk can be further reduced. As a result, it is possible to further reduce the risk of copyright infringement when a product is generated using the AI.

For example, when the name of a famous character is included in the character information for causing the AI to generate a product, it is determined that there is a copyright infringement risk. Therefore, the production of a product having a high copyright infringement risk can be suppressed in advance.

Furthermore, the copyright risk determination apparatus (the cloud server 2) includes the second risk determination section (the controller 21) that calculates, based on the character information, the similarity between the product generated by the AI and the existing copyrighted material and determines the risk of similarity.

Therefore, it is possible to further reduce the risk of copyright infringement when a product is generated using the AI.

For example, it is determined whether the image generated by AI is directly similar to the existing object.

Furthermore, the copyright risk determination apparatus (cloud server 2) includes an extraction section (controller 21) that extracts a feature of a product as feature information. The copyright risk determinatoin apparatus (cloud server 2) includes a third risk determination section (controller 21) that determines the presence of an existing copyrighted material similar to the characteristic on the basis of the feature information and determines a similar risk.

Therefore, it is possible to further reduce the risk of copyright infringement when a product is generated using the AI.

For example, it is possible to determine the presence or absence of images that are not so similar in terms of the images themselves but have similar features. Specifically, a cat type robot based on blue and white is highly likely to resemble a famous character, and it is determined that the product imitates the character.

Furthermore, the copyright risk determination system 100 is a copyright risk determination system including a copyright risk determination apparatus (the cloud server 2) and a display device (the image generation supporting apparatus 1). In the copyright risk determination system 100, the copyright risk determination apparatus includes a result notification section (controller 21) that causes a display device to display a determination result.

Therefore, it is possible to further reduce the risk of copyright infringement when a product is generated using the AI.

Furthermore, the copyright risk determination system 100 is a copyright risk determination system including a copyright risk determination apparatus (the cloud server 2) and a display device (the image generation supporting apparatus 1). In the copyright risk determination system 100, the copyright risk determination apparatus includes a warning section (controller 21) that causes a display device to display warning information if at least one of the first determination section, the second determination section, and the third determination section determines that there is a risk.

Therefore, it is possible to further reduce the risk of copyright infringement when a product is generated using the AI.

The copyright risk determination method is a copyright risk determination method in a copyright risk determination apparatus (cloud server 2) for determining a copyright infringement risk of a product generated by AI. The copyright risk determination method includes a first risk determination step (step S2) of determining a risk that character information for causing an AI to generate a product is related to an existing copyrighted material.

Therefore, it is possible to further reduce the risk of copyright infringement when a product is generated using the AI.

Further, the program causes the computer of the copyright risk determination apparatus (cloud server 2) that determines the copyright infringement risk of the product generated by the AI to function as a first risk determination section that determines the risk that the character information for causing the AI to generate the product is related to the existing copyrighted material.

Therefore, it is possible to further reduce the risk of copyright infringement when a product is generated using the AI.

Hereinabove, the present disclosure has been specifically described with reference to the embodiment, but it goes without saying that the present disclosure is not limited to the above-described embodiment and can be appropriately modified within the scope not departing from the spirit thereof.

For example, in the above description, an example in which a hard disk, a semiconductor nonvolatile memory, or the like is used as a computer-readable medium of the program according to the present disclosure has been disclosed, but the present disclosure is not limited to this example. As other computer-readable recording media, portable recording media such as CD-ROMs can be applied.

The detailed configuration and the detailed operation of each component can be appropriately changed without departing from the spirit and scope of the invention.

Although embodiments of the present invention have been described and illustrated in detail, the disclosed embodiments are made for purposes of illustration and example only and not limitation. The scope of the present invention should be interpreted by terms of the appended claims.

What is claimed is:

1. A copyright risk determination apparatus comprising a hardware processor that determines a risk that character information for causing an AI to generate a product is related to an existing copyrighted material.

2. The copyright risk determination apparatus according to claim 1, wherein the hardware processor calculates, based on the character information, a similarity between the product generated by the AI and the existing copyrighted material, and determines a risk of similarity.

3. The copyright risk determination apparatus according to claim 2, wherein
the hardware processor is configured to:
extract a feature of the product as feature information; and
determine presence or absence of the existing copyrighted material similar to the feature based on the feature information, and determines the risk of similarlity.

4. The copyright risk determination apparatus according to claim 3, wherein the hardware processor determines the risk by using a large-scale language model learned in advance based on an existing copyrighted material and comparing information input to the large-scale language model with the existing copyrighted material.

5. A copyright risk determination system comprising the copyright risk determination apparatus according to claim 1 and a display device, wherein the hardware processor of the copyright risk determination apparatus causes the display device to display a risk determination result.

6. A copyright risk determination system comprising the copyright risk determination apparatus according to claim 1 and a display device, wherein the hardware processor of the copyright risk determination apparatus causes the display device to display warning information if it is determined that there is a risk.

7. A copyright risk determination method in a copyright risk determination apparatus for determining a copyright infringement risk of a product generated by an AI, the method comprising
first risk determining of determining a risk that character information for causing the AI to generate the product is related to an existing copyrighted material.

8. A non-transitory computer-readable storage medium storing a program for a computer of a copyright risk determination apparatus that determines a copyright infringement risk of a product generated by an AI, the program causing the computer to function as
a first risk determiner that determines a risk that character information for causing the AI to generate the product is related to an existing copyrighted material.
